(19) United States
(12) Patent Application Publication
(10) Pub. No.: US 2016/0379212 A1
(43) Pub. Date: Dec. 29, 2016

(54) SYSTEM, APPARATUS AND METHOD FOR PERFORMING CRYPTOGRAPHIC OPERATIONS IN A TRUSTED EXECUTION ENVIRONMENT

(71) Applicant: Intel Corporation, Santa Clara, CA (US)

(72) Inventors: Mic Bowman, Beaverton, OR (US); James P. Held, Portland, OR (US); Jesse Walker, Hillsboro, OR (US)

(21) Appl. No.: 14/751,407

(22) Filed: Jun. 26, 2015

(51) Int. Cl. G06Q 20/38; G06Q 20/40

(52) U.S. Cl. CPC G06Q 20/38215; G06Q 20/401; G06Q 20/3829; G06Q 20/3827; G06Q 2220/00

(57) ABSTRACT

In one embodiment, an apparatus includes a calculation logic to receive a plurality of wait certificates, each associated with a validated block of transactions of a distributed ledger system, and to generate a local mean value based thereon; a timer generation logic to generate a wait time for a proof of wait associated with a first block of transactions of the distributed ledger system based at least in part on the local mean value; a timer logic to identify when the wait period has expired; and a certificate generation logic to generate a wait certificate for the first block of transactions responsive to expiration of the wait period, the wait certificate to validate the first block of transactions. Other embodiments are described and claimed.

### TECHNICAL FIELD

Embodiments relate to security of electronic transactions.

### BACKGROUND

As computing capabilities increase and more electronic commerce occurs, more users are adopting cryptographic-based currency applications. A proof-of-work (PoW) function is used to provide a verifiable average random delay incorporated by crypto-currencies such as Bitcoin to ensure the integrity of a distributed transaction ledger, by randomly designating who among transaction validators may complete a task to update the ledger. Bitcoin's PoW algorithm is based on a random search using a hash function (secure hash algorithm (SHA256)) that is extremely compute and therefore energy-intensive. The Bitcoin protocol periodically adjusts the amount of computation required, in order to maintain an average delay, in response to improving hardware performance. This protocol thus continually increases the energy cost, which is a major cost of transaction processing.

### BRIEF DESCRIPTION OF THE DRAWINGS

FIG. 1 is a block diagram of a trusted execution environment in accordance with one embodiment of the present invention.

FIG. 2 is a flow diagram of a method in accordance with an embodiment of the present invention.

FIG. 3 is a block diagram of a system arrangement in accordance with an embodiment of the present invention.

FIG. 4 is a block diagram of a system in accordance with another embodiment of the present invention.

### DETAILED DESCRIPTION

In various embodiments, an energy efficient function is provided to enable validations to occur in a distributed ledger system, where the function has a fixed computation cost. Use of this function may greatly reduce the cost of verification of a block of transactions. Embodiments can be implemented on any server system or client system with trusted execution environment hardware. As such, embodiments enable a wide range of compute nodes to be competitive as transaction processors, thus restoring an original trust assumption on which many crypto-currency protocol designs were based.

More specifically, a trusted execution environment (TEE) of a processing system may be used to reliably verify information for a distributed ledger system such as a given crypto-currency system. In various embodiments, this verification may be a proof of work, realized more specifically as a proof of wait, namely that the trusted execution environment can attest that only a single attempt to validate a block of transactions of the distributed ledger system occurred within a given wait period, where this wait period itself is dynamically determined within the trusted execution environment.

Although the scope of the present invention is not limited in this regard, embodiments may implement a TEE within a given processing system, such as a server computer, desktop computer or even portable computer. As examples, the TEE may be implemented using one or more Intel® Software Guard Extensions (SGX) enclaves or other protected domain of a system. These technologies, along with platform infrastructure software can offer a TEE by isolating memory regions from an operating system (OS) and providing access control rules around memory regions, to only allow access to authorized entities. In another embodiment, an intellectual property (IP) block in a platform chipset or integrated into an uncore of a processor package can provide a TEE, such as using a converged security manageability engine (CSME). In still other embodiments, a TEE may be implemented using Intel® TXT technology, an ARM TrustZone, or any other secure container, enclave or so forth.

By providing a proof of wait technique to be executed within a trusted execution environment, the safety and randomness of a leader election process based on a guaranteed wait time is ensured. More specifically, embodiments avoid performing expensive busy work while preserving the integrity of transaction validation.

Using an embodiment, fewer resources are consumed in performing transaction validation. For example, at the price of energy in early 2015, the Bitcoin proof of work algorithm is estimated to consume on the order of $10 in electricity per transaction block validated. In contrast, a proof of wait technique in accordance with an embodiment consumes very little power during a wait period, calculated in accordance with an embodiment. Note that during this wait period, a processor and/or an entire verifier system may be placed into a low power state, to further reduce power consumption.

Still further, using an embodiment of the present invention, a proof of wait as described herein can be performed efficiently on general-purpose hardware, avoiding dedicated, special-purpose solutions. By avoiding special-purpose hardware and reducing operating costs, the barrier to entry to validation is lowered, enabling much broader participation in the validation process and increasing the overall robustness of validation (as a larger population of validators makes manipulation of process significantly more difficult).

As discussed above, some crypto-currencies such as Bitcoin rely on a proof of work computation to randomly choose a leader for validating a block of transactions. Bitcoin's proof of work includes the search for a short string (a “nonce”) that, when added to a block of transactions, results in a hash of the block that begins with a sequence of leading zeroes (that is, it is less than some threshold). Bitcoin validators repeatedly guess the string and then test it by hashing the block until an appropriate string is found. The hash function ensures that the number of trials required to find the sequence is randomly distributed. The number of leading zeroes required in the answer is adjusted by the protocol to ensure that on average it takes about 10 minutes to find the correct nonce for a block.

In effect, this protocol implements a lottery to determine who can update the ledger, where the winner is randomly chosen and where the price of a ticket is the cost of the proof of work. For the purpose of achieving decentralized consensus for transaction ledger update, a good lottery function has several characteristics: the function randomly distributes the leader election across a broadest possible population of participants; the cost of controlling the election should be proportional to the value to be gained from it; and it is computationally efficient for all participants to verify that the leader was legitimately selected.

Using a proof of wait technique rooted in a trusted execution environment ensures the safety and randomness of the leader election process without requiring the costly investment of power (thus increasing the population of validators). More specifically, a guaranteed wait time is provided through a trusted execution environment.

This wait timer for a given transaction block is guaranteed to have been created by the TEE. And generation of a wait certificate verifies that the timer was created by the TEE (and has expired). This wait certificate is thus an attestation that can be used to verify that a validator did, in fact, wait the allotted time before claiming the leadership role. In an embodiment, key distribution through a direct anonymous attestation (DAA) scheme can be used for the validation to generate the wait certificate.

Note that the random distribution is a function returning values sampled according to a probabilistic distribution, which may be adopted by a crypto-currency community. In various embodiments, any distribution of wait times may be used, such as uniform, Poisson, Erlang, etc.; however, the distribution may be compatible with other goals of a given crypto-currency system. Probabilistic distributions may be parameterized by a mean which represents the central tendency or the average value of the distribution. As an example, the time to validate Bitcoin crypto-currency transactions is a Poisson distribution with a mean of 10 minutes (meaning that a solution to the hash problem will be found approximately every 10 minutes).

In embodiments described herein, the following terms are used.
Validator—an entity that runs a program to validate blocks of transactions.
Validation—process of demonstrating the correctness of a block of transactions and adding it to the universally agreed upon history of accepted blocks.
Committed—a block (or a transaction within a block) that has been validated and added to the universal history of accepted blocks.
Global Distribution—random distribution of time required for successful block validation viewed over the entire set of validators.
Global Distribution Mean—the average time required for successful block validation viewed over the entire set of validators; this value is generally agreed upon by the participants in the system.
Local Distribution—random distribution of time required for a single validator to validate a block (such that the global distribution mean is maintained).
Local Distribution Mean—the average time required for a single validator to validate a block. This value may be computed in such a way as to ensure that the Global Distribution Mean is maintained.
Wait Timer—a certificate that can be verified by a local TEE, contains a previous block identifier, a start/end time duration, and a local distribution mean used to generate the interval, and which can be redeemed for a Wait Certificate when the end time has expired.
Wait Certificate—a certificate that can be verified by any TEE, and which contains a TEE identity, previous block identifier, a start/end time duration, and the local distribution mean used to generate the interval, which proves that the validator generated a wait timer and waited the computed interval.

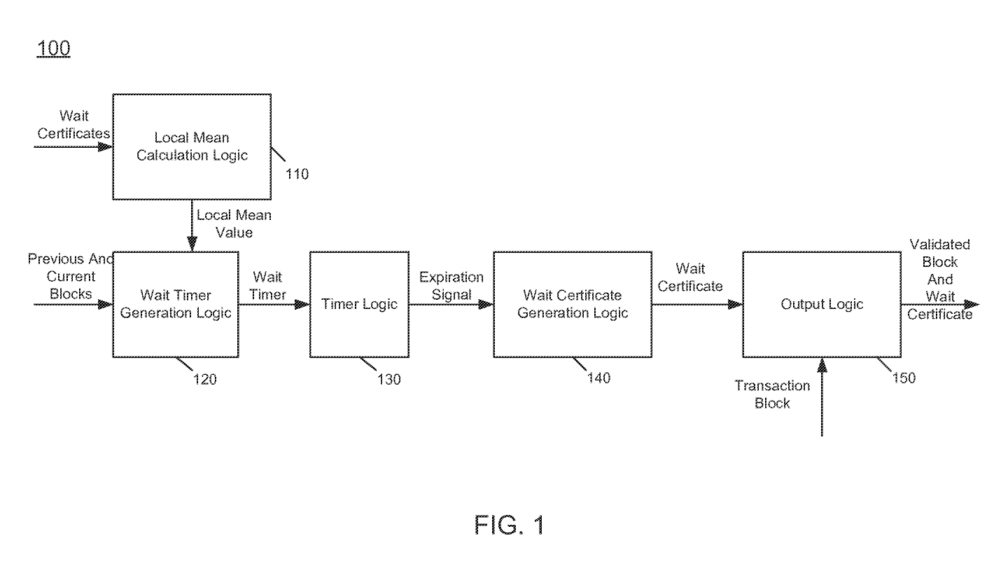

Referring now to FIG. 1, shown is a block diagram of a trusted execution environment in accordance with one embodiment of the present invention. In the embodiment shown in FIG. 1, TEE 100 may be implemented as combinations of hardware, software, and/or firmware. In one embodiment, TEE 100 may be implemented at least in part within a dedicated security hardware of a multicore processor or other system on chip (SoC). For example, TEE 100 may be implemented as a security coprocessor, a CSME, a hardware accelerator or so forth.

TEE 100 includes calculation logic for the mean of the distribution of wait periods. As seen, calculation logic 110 is coupled to receive a plurality of wait certificates, which may be wait certificates associated with one or more previously validated blocks of transactions. Such wait certificates may be for each block of a committed block chain, and may include various information, including a start time, an expiration time, a mean of a probability distribution, and information regarding a previous and current block of transactions to be validated. From at least some of this information, calculation logic 110 may determine a mean for the distribution of wait periods for a current block of transactions to be validated, referred to herein as a local mean value.

Still with reference to FIG. 1, calculation logic 110 provides the local mean value to a wait timer generation logic 120. In general, timer generation logic 120 is configured to generate a wait value, also referred to herein as a timer value, which may be used to indicate, upon expiration, completion of a given wait period. As further illustrated, wait timer generation logic 120 receives additional incoming information, including one or more previously validated blocks of transactions. More specifically, in an embodiment timer generation logic 120 receives a previous block of validated transactions (along with its wait certificate) and the current block to potentially be validated. In an embodiment, this previous block may be the most recently committed transaction block. From this information, wait timer generation logic 120 generates a wait value. As will be described herein, this wait value can be determined by a given function or routine, which may be implemented within a TEE.

Still referring to FIG. 1, the timer value is provided to a timer logic 130. In an embodiment, timer logic 130 is configured to determine when the wait period has expired. In an embodiment, timer logic 130 may be configured to count clock cycles of a processor and based on the number of clock cycles counted, determine a timer expiration. Responsive to the expiration of this wait period, timer logic 130 generates an expiration signal, which it communicates to a wait certificate generation logic 140.

In various embodiments, wait certificate generation logic 140 may generate a wait certificate for the current block of transactions responsive to receipt of this expiration signal. In an embodiment, wait generation logic 140 may generate the wait certificate based at least in part on a verification of the calculation of the wait period by the TEE, and that the wait period has expired. As will be described herein, this wait certificate can be generated by a given function or routine, which may be implemented within a TEE. This wait certificate, in an embodiment may include the start and end time of the wait period, the local mean value, a hash value of a previous block of validated transactions and a hash value of the current block of transactions. In an embodiment, wait certificate generation logic 140 outputs the wait certificate to an output logic 150, which may be configured to send from the processing system the now validated block of transactions, along with the corresponding wait certificate.

Understand while illustrated at this high level in the embodiment of FIG. 1, variations and alternatives are possible. For example, in other embodiments at least some of the logic shown in FIG. 1 may be outside of a TEE. In one case the only logic blocks shown in FIG. 1 that are present within the TEE are the wait timer generation logic and the wait certificate generation logic.

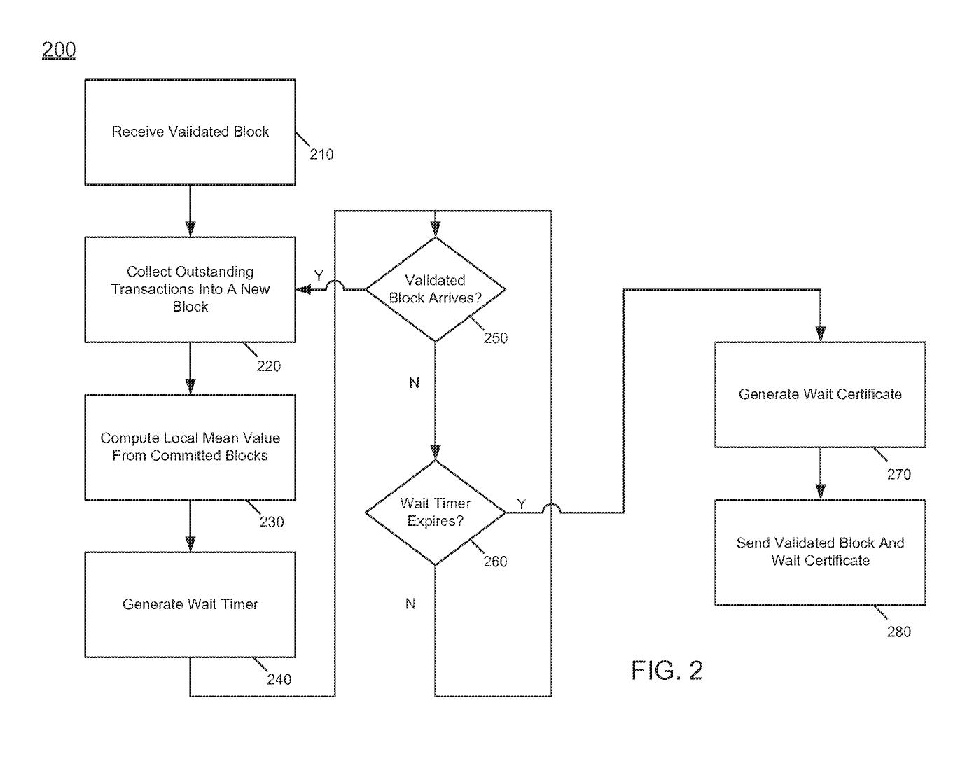

Referring now to FIG. 2, shown is a flow diagram of a method in accordance with an embodiment of the present invention. More specifically, method 200 of FIG. 2, which may be performed by appropriate combinations of hardware, software, and/or firmware (including a TEE such as in FIG. 1), may be used to validate a block of transactions in a distributed ledger system.

As shown, method 200 begins responsive to receipt of a validated block of transactions (block 210). This validated block of transactions may be received in a given verifier processing system from another processing system of the distributed ledger system, and may correspond to a previous block of validated transactions. Received along with this block of transactions is a wait certificate associated with that block of transactions.

Next, control passes to block 220 where outstanding transactions may be collected and placed into a new block. Then at block 230 a local mean value can be computed from a chain of committed blocks, which is a subset of a committed chain. Note that in some embodiments, the length of the subset is not fixed. In an embodiment, this local mean value may be generated according to a random distribution calculation, details of which are discussed further below.

Still with reference to FIG. 2, next a wait timer is created (block 240). In an embodiment, this wait timer is generated within the TEE and may be based on the local mean value calculated, as well as information associated with current and previous blocks of transactions (e.g., hash values associated with these transaction blocks). Next after this wait timer is created, the system may enter into a low power state for the duration of the wait period, or the system may perform other processing operations (e.g., of one or more other applications).

Note that prior to expiration of the timer it can be determined whether a validated block of transactions arrives (block 250). Note that this validated block of transactions may be received from another verification system that won a lottery for this current block of transactions. As such, no further operations are taken with regard to the current block of transactions and control passes back to block 220. If instead no validated block is received, control next passes to diamond 260 to determine whether the wait time has expired. If so (and no validated block arrives prior to this expiration), this means that the verifier system won the lottery.

Accordingly, control passes to block 270 where a wait certificate can be generated for the block of transactions. This wait certificate may be generated to include start and end times, the local mean value, and hash values for previous and new blocks, in an embodiment. Thereafter at block 280 this validated block may be sent along with the corresponding wait certificate to various entities of the distributed ledger system, such as a plurality of other verifier systems. Understand while shown at this high level in the embodiment of FIG. 2, many variations and alternatives are possible.

In some cases, prior to receipt of a sufficient number of validated blocks (and corresponding wait certificates) calculation of a local mean value may not be very accurate. Accordingly, embodiments may provide an initialization technique to better estimate the local mean value without sufficient samples. In an embodiment, an initial wait time, which is a configuration value corresponding to a local mean value to use for an initial block, can be selected such that the local mean value is a target wait time (which is an configuration value of a target mean for time between global block validations) when an initial sample size number of blocks have been validated. Note that this initial sample size is the number of blocks to be used for slow ramp initialization.

More specifically, in one embodiment the following calculations may be performed to determine a local mean value for initialization:

Ratio=LengthOfCurrentChain/InitialSampleSize [EQ. 1]

LocalMean=TargetWaitTime*(1−Ratio²)+InitialWaitTime*Ratio² [EQ. 2].

In Equations 1 and 2: InitialSampleSize is the number of blocks to use for the initialization phase of Local Distribution Mean computation; InitialWaitTime is the Local Distribution Mean to use when entering the initialization phase (for the first block in the chain); and TargetWaitTime is the Local Distribution Mean when exiting the initialization phase (for the “InitialSampleSize” block). Note that a SampleSize is a number of blocks used to compute the steady state Local Distribution Mean once an initialization phase is complete; this value is generally agreed upon by the participants in the system.

As described above, in various embodiments a TEE may be used to calculate a wait timer for a given block of transactions to be validated. Note that first, various definitions for a trusted code class of execution and keys to be used in signing operations for a wait timer and a wait certificate may occur.

TABLE 1

class TrustedCode :

time ExpireTime
key TimerKey
key BlockChainKey

Thereafter, a create timer function may be called within the TEE to calculate this wait timer. In an embodiment, the computed local mean value, a most recently block of committed transactions, and a block to be validated, may be provided as inputs to this function. Referring now to Table 2, shown is an example pseudo-code for calculation of a wait timer value in accordance with an embodiment of the present invention.

TABLE 2
def CreateTimer(self, LocalMean, PreviousTxnBlockID, TxnBlock) :

StartTime = max(now( ), ExpireTime)
ExpireTime = StartTime + RandomDistribution(LocalMean)
return SIGN(TimerKey, [ StartTime, ExpireTime, LocalMean,
PreviousBlockID, TxnBlock ])

As shown in Table 2, the function may receive as inputs a previous block ID, which is a hash value of a previously validated block, a current block ID, which is a hash value of the current block of transactions to be validated, and a local mean value, which is the mean of the exponential distribution. This function returns a start time value, an end time value, the local mean value, and hash values of the previous and current blocks of transactions (PrevID and CurrentID). In an embodiment, this wait timer value may be cryptographically signed, e.g., by a local key as this wait value is only to be verified locally (namely within the same TEE in which the wait value itself is generated). In one embodiment, the end time may be computed in accordance with Equation 3: ln(hash(LocalIEPIDKey, PrevID))*LocalMean [EQ. 3]. EQ. 3 uses the identifier for the TEE and the identifier for the previous block of committed transactions to generate a uniformly distributed random number. The natural logarithm of the uniformly distributed random number is exponentially distributed with a distribution mean of 1. Multiplying by LocalMean, which is the local mean value, creates an exponential distribution with distribution mean of LocalMean. Thus the wait timer value computed by EQ. 3 will have an exponential distribution with distribution mean equivalent to LocalMean.

In an embodiment, the local mean computation may be used to determine a minimum value of a global distribution of values. This local mean value may be based at least in part on global knowledge, including the local mean value used for each block of the committed chain and a wait duration for each block, where this wait duration is a sample of the global distribution.

Referring now to Equation 4, Pr, a probability distribution function may be used to estimate the population size and compute the local mean that will approximate the correct global mean:

$$( X = min \{ {X}_{1} , … , {X}_{n} \} ) = \frac{λ}{{λ}_{1} + … + {λ}_{n}} . \qquad [ EQ . 4 ]$$

In Equation 4, X is the Global Distribution, λ of the numerator is the Global Distribution Mean, Xᵢ is the Local Distribution, and individual λᵢ of the denominator are the Local Distribution Means. In embodiments, all of the individual lambdas are equivalent.

Note that by communication of the calculated local mean value in a wait certificate for a validated block, any third party entity receiving the wait value and the validated block can verify the local mean associated with that block.

At the conclusion of the wait period, a timer expiration or other expiration signal may be triggered and sent to the TEE in order to create the wait certificate (assuming that no other validated block of transactions has been received in the system before the expiration of the wait timer). In an embodiment, a wait certificate creation function can verify that the wait timer was generated by a call to a function executing in a TEE, and that the time has expired.

Referring now to Table 3, shown is example pseudo-code for generating a wait certificate in accordance with an embodiment of the present invention.

TABLE 3
def CheckTimer(self, Timer) :
if timer.ExpireTime > now( ) :

return SIGN(BlockChainKey, [ StartTime, ExpireTime, LocalMean,
PreviousBlockID, TxnBlock ] )

As shown in Table 3, the function may receive the expired timer and verify that the time in the expired timer has expired. Included in the created wait certificate may be a start time, end time, local mean value, and hash values for the previous validated block and the current validated block.

In an embodiment, this certificate may be signed by a local group key which, in one embodiment may be a local enhanced privacy identifier (EPID) group key, e.g. generated using an Intel® processor. Note that this signed wait certificate can be verified in an external third party system that does not have a trusted execution environment, using a global group key. Understand while shown with this particular pseudo-code in Table 3, variations and alternatives are possible.

An embodiment thus meets the criteria for a good lottery algorithm. It randomly distributes leadership election across the entire population of validators with a distribution that is similar to what is provided by lottery algorithms. The probability of election is proportional to the resources contributed (in this case, resources are trusted execution environments). In an embodiment, third parties may validate an election by use of an EPID and a group key for verifying the signed attestation.

In order to submit a new block for validation, the winner of the lottery can prove it abided by the protocol. To do this, a hardware-based DAA algorithm can be used to sign the block before it is submitted to the community as the next block of the block chain. In an embodiment, a reserved indicator of the block is also set to assert that the block was created via a proof-of-wait algorithm, instead of a proof-of-work algorithm. Members of the crypto-community can verify the DAA signature on the block whenever a new header indicator is set; the semantic of the DAA signature is that the signer attests that it faithfully followed the procedure.

Any attestation provides a random challenge to prove liveness. Embodiments are secure since each block includes a hash of the previous block as well as a nonce. Since this hash value is unpredictable before the prior block was constructed, the signature proves that the signer could not have begun its proof-of-wait execution before the lottery to choose the leader for the current block. Embodiments thus provide a TEE to create a certifiable randomized delay as a tool in distributed systems where proof of work is typically used.

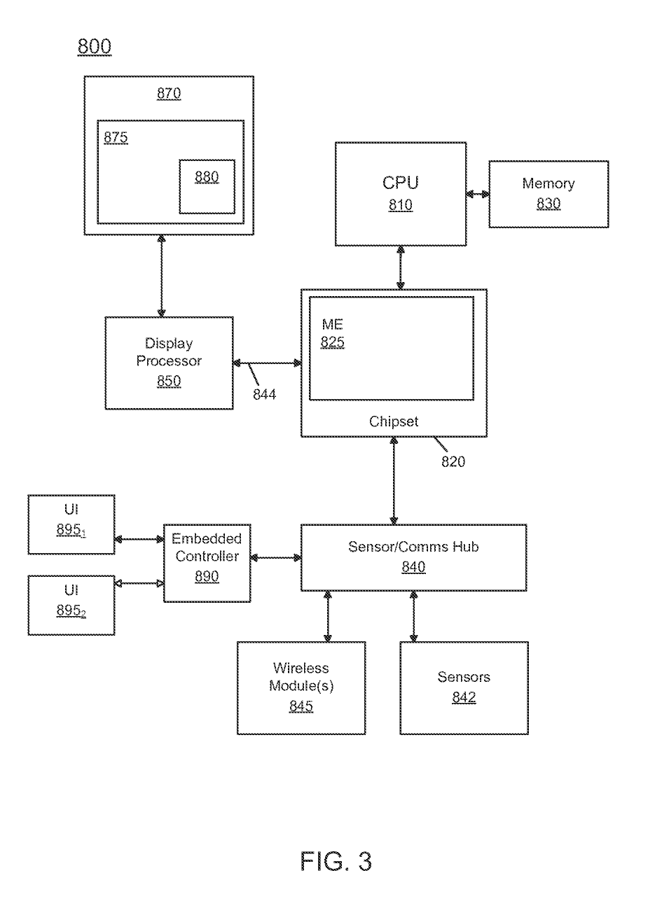

Embodiments may be implemented in a variety of systems, as described above. Referring now to FIG. 3, shown is a block diagram of a system arrangement in accordance with an embodiment of the present invention. As seen in FIG. 3, system 800 may be a given platform such as a mobile device, tablet, phablet, personal computer, server computer (or other form factor) and includes a CPU 810. In various embodiments, this CPU may be a SoC or other multicore processor and can include secure execution technologies to set up a trusted execution environment (TEE). In different embodiments, the TEE may be implemented using Intel® SGX technology, Intel® TXT technology, or an ARM TrustZone.

As seen in the embodiment of FIG. 3, CPU 810 may be coupled to a chipset 820. Although shown as separate components in the embodiment of FIG. 3, understand that in some implementations chipset 820 may be implemented within the same package as CPU 810, particularly when the CPU is implemented as an SoC. Chipset 820 may include a manageability engine 825, which in an embodiment may be configured to perform the proof of wait-based validations described herein. As further seen, various portions of a memory system couple to CPU 810, including a system memory 830 (e.g., formed of dynamic random access memory (DRAM)).

In the embodiment of FIG. 3, additional components may be present including a sensor/communications hub 840 which may be a standalone hub or configured within chipset 820. As seen, one or more sensors 842 may be in communication with hub 840. For purposes of user authentication and device/context attestation, such sensors can include biometric input sensors, one or more motion sensor devices, and a global positioning system (GPS) module or other dedicated location sensor. In an embodiment, other sensors such as inertial and environmental sensors also may be present. As several examples, an accelerometer and a force detector may be provided and information obtained from these sensors can be used for the motion-based authentications described herein. Also, in various embodiments one or more wireless communication modules 845 may be present to enable communication with local or wide area wireless networks such as a given cellular system in accordance with a 3G or 4G/LTE communication protocol.

As further seen in FIG. 3, platform 800 may further include a display processor 850 that can be coupled to chipset 820 via channel 844, which may be a trusted channel, in some embodiments. As seen, display processor 850 may couple to a display 870 that can be a touch screen display to receive user input such as responses to authentication requests. Thus in this example, configured within the display may be a touch screen 875 and a touch screen controller 880 (which of course is hidden behind the display itself). Other user interfaces, namely user interfaces 895₁ and 895₂ which in an example can be a keyboard and a mouse, may be coupled via an embedded controller 890 to sensor/communications hub 830.

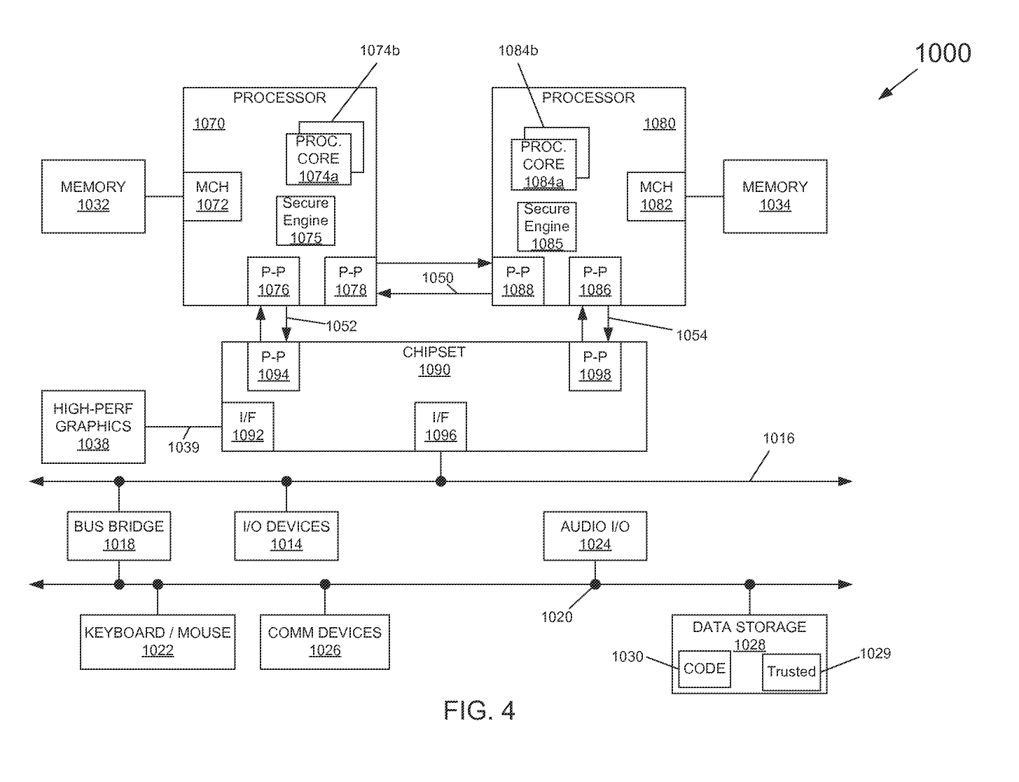

Referring now to FIG. 4, shown is a block diagram of a system in accordance with another embodiment of the present invention. As shown in FIG. 4, multiprocessor system 1000 is a point-to-point interconnect system such as a server system, and includes a first processor 1070 and a second processor 1080 coupled via a point-to-point interconnect 1050. As shown in FIG. 4, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include a secure engine 1075 and 1085 to perform security operations, including the proof of wait for distributed ledger systems as described herein.

Still referring to FIG. 4, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 4, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 4, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 4, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028. As seen, data storage unit 1028 may include code 1030, in one embodiment. As further seen, data storage unit 1028 also includes a trusted storage 1029, which may store one or more proof of wait routines, as described herein. Further, an audio I/O 1024 may be coupled to second bus 1020.

The following Examples pertain to further embodiments.

In Example 1, an apparatus comprises: a calculation logic to receive a plurality of wait certificates, each of the plurality of wait certificates associated with a validated block of transactions of a distributed ledger system, and to generate a local mean value based thereon; a timer generation logic to generate a wait period for a proof of wait associated with a first block of transactions of the distributed ledger system based at least in part on the local mean value; a timer logic to identify when the wait period has expired; and a certificate generation logic to generate a wait certificate for the first block of transactions responsive to expiration of the wait period, the wait certificate to validate the first block of transactions.

In Example 2, the calculation logic is to calculate the local mean value based on a probabilistic distribution.

In Example 3, the timer generation logic is to generate the wait period further based on a first hash value associated with the first block of transactions and a second hash value associated with the validated block of transactions.

In Example 4, the apparatus of one or more of the above Examples further comprises a trusted execution environment comprising the timer generation logic and the certificate generation logic.

In Example 5, the apparatus of Example 4 further comprises an output logic to send the validated first block of transactions and the wait certificate to a plurality of systems of the distributed ledger system.

In Example 6, the wait certificate is to further verify that the apparatus generated only a single wait certificate for the first block of transactions.

In Example 7, the validated first block of transactions comprises a header having a first indicator to indicate that the validated first block of transactions was validated using a proof of wait.

In Example 8, the apparatus of one or more of the above Examples comprises a multicore processor including a plurality of cores and a security agent.

In Example 9, the security agent of Example 8 is to execute in a trusted execution environment, the security agent comprising at least the timer generation logic and the certificate generation logic.

In Example 10, a method comprises: generating, in a TEE of a first processing system, an expiration time to indicate a proof of wait for validation of a block of transactions of a distributed ledger system; determining whether the expiration time has been reached; and responsive to the determination that the expiration time has been reached, generating, in the TEE, a wait certificate to verify expiration of the expiration time and that the expiration time was generated in the TEE, the wait certificate to be submitted from the first processing system to the distributed ledger system to validate the block of transactions.

In Example 11, the wait certificate is not generated if a validated block of transactions associated with the block of transactions is received before the expiration time has been reached.

In Example 12, the method further comprises generating the expiration time based at least in part on a local mean value, the local mean value calculated in the trusted execution environment.

In Example 13, the method further comprises calculating the local mean value according to a random distribution of wait times for a plurality of previously validated transaction blocks.

In Example 14, the method further comprises generating the expiration time based at least in part on a first hash value of the block of transactions, a second hash value of a block of previous transactions, and the local mean value.

In Example 15, the method further comprises signing the wait certificate with a local group key, where an external agent is to verify the wait certificate using a global group key.

In Example 16, the distributed ledger system comprises a crypto-currency system.

In another example, a computer readable medium including instructions is to perform the method of any of the above Examples.

In another example, a computer readable medium including data is to be used by at least one machine to fabricate at least one integrated circuit to perform the method of any one of the above Examples.

In another example, an apparatus comprises means for performing the method of any one of the above Examples.

In Example 17, a method comprises: collecting, in a processing system, outstanding transactions of a distributed ledger system into a first block of transactions; computing a local mean value from a block chain of one or more prior validated blocks of transactions of the distributed ledger system; calling a timer function of a TEE of the processing system to determine an expiration time for a wait period, the timer function to determine the expiration time based at least in part on a first hash value of a prior validated block of transactions, a second hash value of the first block of transactions, and the local mean value; responsive to the expiration time for the wait period, calling a certificate function of the TEE to generate a wait certificate to verify that the wait period has expired and that the expiration time was determined in the TEE; and after generating the wait certificate, sending the first block of transactions from the processing system as a validated block of transactions.

In Example 18, the method of Example 17 further comprises sending the wait certificate with the validated block of transactions.

In Example 19, the method of Example 18 further comprises signing the wait certificate with a local key associated with the TEE, where an external verifier can verify the wait certificate using a global key.

In Example 20, the method of Example 17 further comprises including the local mean value, the first hash value, the second hash value in the wait certificate.

In Example 21, a system comprises: means for collecting outstanding transactions of a distributed ledger system into a first block of transactions; means for computing a local mean value from a block chain of one or more prior validated blocks of transactions of the distributed ledger system; means for calling a timer function of a TEE of the system to determine an expiration time for a wait period, the timer function to determine the expiration time based at least in part on a first hash value of a prior validated block of transactions, a second hash value of the first block of transactions, and the local mean value; means for calling a certificate function of the TEE to generate a wait certificate to verify that the wait period has expired and that the expiration time was determined in the TEE; and means for sending the first block of transactions from the processing system as a validated block of transactions.

In Example 22, the system of Example 21 further comprises means for sending the wait certificate with the validated block of transactions.

In Example 23, the system of Example 22 further comprises means for signing the wait certificate with a local key associated with the TEE, where an external verifier can verify the wait certificate using a global key.

In Example 24, the system of Example 21 further comprises means for including the local mean value, the first hash value, and the second hash value in the wait certificate.

Understand that various combinations of the above examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a calculation logic to receive a plurality of wait certificates, each of the plurality of wait certificates associated with a validated block of transactions of a distributed ledger system, and to generate a local mean value based thereon;
a timer generation logic to generate a wait period for a proof of wait associated with a first block of transactions of the distributed ledger system based at least in part on the local mean value;
a timer logic to identify when the wait period has expired; and
a certificate generation logic to generate a wait certificate for the first block of transactions responsive to expiration of the wait period, the wait certificate to validate the first block of transactions.

2. The apparatus of claim 1, wherein the calculation logic is to calculate the local mean value based on a probabilistic distribution.

3. The apparatus of claim 1, wherein the timer generation logic is to generate the wait period further based on a first hash value associated with the first block of transactions and a second hash value associated with the validated block of transactions.

4. The apparatus of claim 1, further comprising a trusted execution environment, the trusted execution environment comprising the timer generation logic and the certificate generation logic.

5. The apparatus of claim 4, further comprising an output logic to send the validated first block of transactions and the wait certificate to a plurality of systems of the distributed ledger system.

6. The apparatus of claim 5, wherein the wait certificate is to further verify that the apparatus generated only a single wait certificate for the first block of transactions.

7. The apparatus of claim 5, wherein the validated first block of transactions comprises a header having a first indicator to indicate that the validated first block of transactions was validated using a proof of wait.

8. The apparatus of claim 1, wherein the apparatus comprises a multicore processor including a plurality of cores and a security agent.

9. The apparatus of claim 8, wherein the security agent is to execute in a trusted execution environment, the security agent comprising at least the timer generation logic and the certificate generation logic.

10. At least one computer readable storage medium comprising instructions that when executed enable a system to:
generate, in a trusted execution environment (TEE) of a first processing system, an expiration time to indicate a proof of wait for validation of a block of transactions of a distributed ledger system;
determine whether the expiration time has been reached; and
responsive to the determination that the expiration time has been reached, generate, in the TEE, a wait certificate to verify expiration of the expiration time and that the expiration time was generated in the TEE, the wait certificate to be submitted from the first processing system to the distributed ledger system to validate the block of transactions.

11. The at least one computer readable medium of claim 10, wherein the instructions further enable the system to not generate the wait certificate if a validated block of transactions associated with the block of transactions is received before the expiration time has been reached.

12. The at least one computer readable medium of claim 10, further comprising instructions that when executed enable the system to generate the expiration time based at least in part on a local mean value, the local mean value calculated in the trusted execution environment.

13. The at least one computer readable medium of claim 12, further comprising instructions that when executed enable the system to calculate the local mean value according to a random distribution of wait times for a plurality of previously validated transaction blocks.

14. The at least one computer readable medium of claim 12, further comprising instructions that when executed enable the system to generate the expiration time based at least in part on a first hash value of the block of transactions, a second hash value of a block of previous transactions, and the local mean value.

15. The at least one computer readable medium of claim 10, further comprising instructions that when executed enable the system to sign the wait certificate with a local group key, wherein an external agent is to verify the wait certificate using a global group key.

16. The at least one computer readable medium of claim 10, wherein the distributed ledger system comprises a crypto-currency system.

17. A method comprising:
collecting, in a processing system, outstanding transactions of a distributed ledger system into a first block of transactions;
computing a local mean value from a block chain of one or more prior validated blocks of transactions of the distributed ledger system;
calling a timer function of a trusted execution environment (TEE) of the processing system to determine an expiration time for a wait period, the timer function to determine the expiration time based at least in part on a first hash value of a prior validated block of transactions, a second hash value of the first block of transactions, and the local mean value;
responsive to the expiration time for the wait period, calling a certificate function of the TEE to generate a wait certificate to verify that the wait period has expired and that the expiration time was determined in the TEE; and
after generating the wait certificate, sending the first block of transactions from the processing system as a validated block of transactions.

18. The method of claim 17, further comprising sending the wait certificate with the validated block of transactions.

19. The method of claim 18, further comprising signing the wait certificate with a local key associated with the TEE, wherein an external verifier can verify the wait certificate using a global key.

20. The method of claim 17, further comprising including the local mean value, the first hash value, and the second hash value in the wait certificate.
